(19) United States
(12) Patent Application Publication
(10) Pub. No.: US 2014/0003191 A1
(43) Pub. Date: Jan. 2, 2014

(54) SYSTEM AND METHOD FOR EVALUATING A TIME-LAPSE SEISMIC SIGNAL RECORDING USING SHIFTED NORMALIZED ROOT MEAN SQUARE METRIC

(71) Applicant: Philip Leon Inderwiesen, Needville, TX (US)

(72) Inventor: Philip Leon Inderwiesen, Needville, TX (US)

(73) Assignee: Chevron U.S.A. Inc, San Ramon, CA (US)

(21) Appl. No.: 13/535,642

(22) Filed: Jun. 28, 2012

(51) Int. Cl. G01V 1/28

(52) U.S. Cl. 367/38

(57) ABSTRACT

A system and a method for evaluating a time-lapse seismic signal recording using shifted normalized root mean square (sNRMS) metric are described. The method includes inputting two seismic traces that include similar or repeatable signals; isolating two signals for analysis from other signals in the two seismic traces, the two signals being time shifted relative to each other; and determining a normalized cross-correlation of the two signals at different time shifts between the two signals. The method further includes determining an optimum time shift closest to zero time shift where the normalized cross-correlation is maximum; computing a shifted normalized root mean square value at the optimum time shift; and determining a repeatability quality of the two signals based on the shifted normalized root mean square value.

### FIELD

The present invention pertains in general to computation methods and more particularly to a computer system and computer-implemented method for evaluating a time-lapse seismic signal recording using shifted normalized root mean square (sNRMS) metric.

### BACKGROUND

Normalized-Root-Mean-Square (NRMS) was introduced in 2002 as a metric to gauge how well a time-lapse seismic monitor signal repeats a baseline seismic signal. However, it was soon discovered by the industry that slight time shifts between monitor and baseline seismic signals would produce anomalous NRMS values negating the NRMS potential as a repeatability metric and analysis parameter. Recently, another time-lapse seismic repeatability metric called signal-to-distortion ratio (SDR) was introduced as a solution to the NRMS deficiency. SDR works as a metric, even with the presence of time shifts. However, SDR loses the ties with random noise and spatial variation in 4D noise that can be intimately tied to the NRMS metric for analysis purposes.

Therefore, there is a need for a method and system for evaluating a time-lapse seismic signal recording to determine, for example, a repeatability quality of the signal recording.

### SUMMARY

An aspect of the present invention is to provide a computer-implemented method for evaluating a time-lapse seismic signal recording using shifted normalized root mean square (sNRMS) metric. The method includes inputting, into a computer, two seismic traces that include similar or repeatable signals; isolating, by the computer, two signals for analysis from other signals in the two seismic traces, the two signals being time shifted relative to each other; and determining, by the computer, a normalized cross-correlation of the two signals at different time shifts between the two signals. The method further includes determining, by the computer, an optimum time shift closest to zero time shift where the normalized cross-correlation is maximum; computing, by the computer, a shifted normalized root mean square value at the optimum time shift; and determining, by the computer, a repeatability quality of the two signals based on the shifted normalized root mean square value.

Another aspect of the present invention is to provide a system for evaluating a time-lapse seismic signal recording using shifted normalized root mean square (sNRMS) metric. The system includes a computer readable memory configured to store input data comprising two seismic traces that include similar or repeatable signals. The system further includes a computer processor in communication with the computer readable memory, the computer processor being configured to: read the input data; isolate two signals for analysis from other signals in the two seismic traces, the two signals being time shifted relative to each other; determine a normalized cross-correlation of the two signals at different time shifts between the two signals; determine an optimum time shift closest to zero time shift where the normalized cross-correlation is maximum; compute a shifted normalized root mean square value at the optimum time shift; and determine a repeatability quality of the two signals based on the shifted normalized root mean square value.

Although the various steps of the method according to one embodiment of the invention are described in the above paragraphs as occurring in a certain order, the present application is not bound by the order in which the various steps occur. In fact, in alternative embodiments, the various steps can be executed in an order different from the order described above or otherwise herein.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a flow diagram of the method for evaluating a time-lapse seismic recording using shifted normalized root mean square (sNRMS) metric, according to an embodiment of the present invention;

FIG. 2 depicts an example of two signals isolated or windowed from two seismic traces that are shifted in time relative to each other, according to an embodiment of the present invention;

FIG. 3 depicts plots of the normalized cross-correlation and the normalized root mean square (NRMS) as a function or the time shift, according to an embodiment of the present invention;

FIG. 4 depicts plots of the normalized cross-correlation and the NRMS as a function or the time shift, after normalizing the two signals, according to another embodiment of the present invention;

FIGS. 5A-5D are plots of the two time-shifted signals (a baseline signal and repeated signals) in different conditions when a repeatability is poor, fair, good, or excellent; and

FIG. 6 is a schematic diagram representing a computer system for implementing the method, according to an embodiment of the present invention.

### DETAILED DESCRIPTION

In one embodiment, in order to evaluate a time-lapse seismic signal recording, instead of using SDR and NRMS metrics, shifted normalized root mean square (sNRMS) metric can be used. Shifted Normalized-Root-Mean-Square (sNRMS) applies to any type of digital signal that is recorded two or more times and for which a metric is needed to compare the signal repeatability (or similarity) from one recording of the signal to another recording of the signal. For example, the repeatability of seismic signals such as recorded reflection seismic events recorded at different times (i.e., time-lapse recorded) can be evaluated using sNRMS metric.

In time-lapse, multiple seismic recordings occur when one or more monitor survey(s) are conducted at a later time (e.g., calendar date) than an earlier baseline seismic survey. For example, this may be performed for the purpose of measuring small differences in the subsurface due to reservoir production. Each position of a seismic source and receiver produces a unique sampling of the subsurface from reflections. The unique sampling is presented to an interpreter as a seismic trace. Hence, to compare, for example, production related changes from associated reflections on seismic traces, a user attempts to repeat, at a later time, the same measurement at the same positions the source and receiver were positioned on the baseline survey which was performed at an earlier time. Because there are essentially no physical changes in the non-reservoir sections, one would expect that the non-reservoir sections of the time-lapse seismic traces would have similar signals or have signals that exhibit a good repeatability if the 4D acquisition was repeated. Shifted normalized root mean square (sNRMS) metric may be applied in this case to evaluate the repeatability or determine the repeatability quality of the measurement(s).

Reflections on seismic traces in a common-reflection-point gather originate from the same subsurface location. sNRMS can measure the similarity or repeatability of the recorded seismic trace (or seismic reflection) across the gather using a combination of trace pairs. The trace pair is useful in understanding random and 4D noise prior to performing a monitor acquisition at a later time.

The word “shifted” in Shifted Normalized-Root-Mean-Square (sNRMS) relates to the fact that one signal is shifted relative to another signal so that the signals are optimally aligned before applying a Normalized Root Mean Square measurement. By performing the shifting, the problem with anomalous NRMS values when applied to signals with relative shifts can be eliminated.

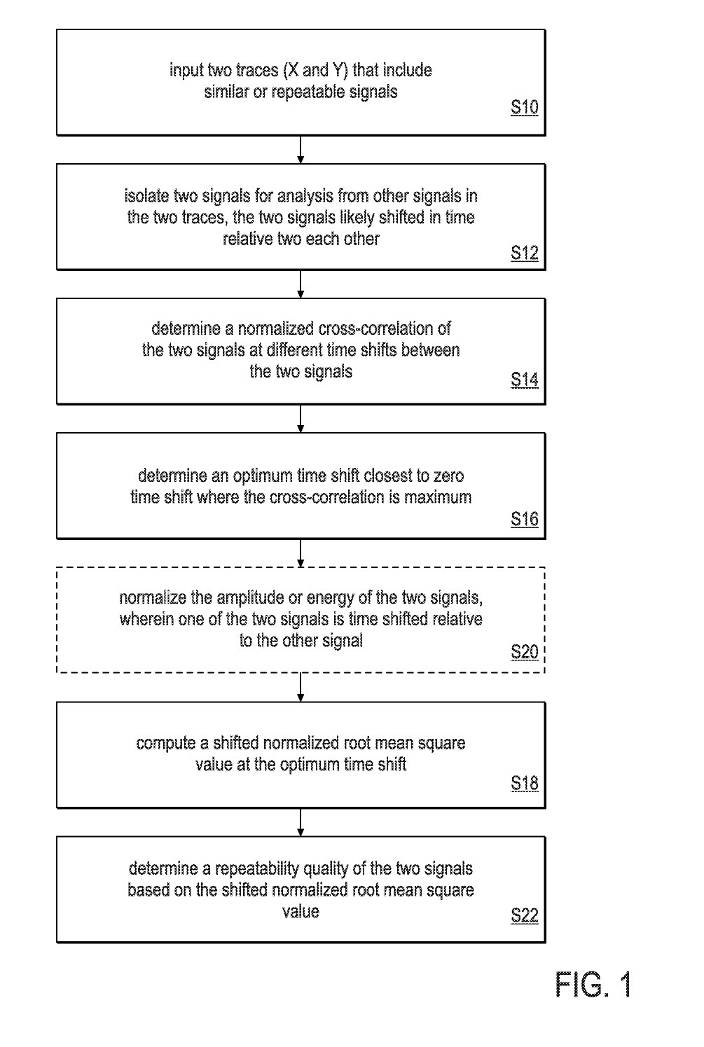

FIG. 1 is a flow diagram of the method for evaluating a time-lapse seismic recording using shifted normalized root mean square (sNRMS) metric, according to an embodiment of the present invention. The method includes inputting two traces (X and Y) that include similar or repeatable signal, at S10. The two traces X and Y being obtained during seismic surveys conducted at different times. The method further includes isolating signals for analysis from other signals in the two traces (X and Y) by selecting a time window or gate in the X and Y traces, at S12. As recorded, the two signals in the two traces are likely to be shifted in time relative to each other.

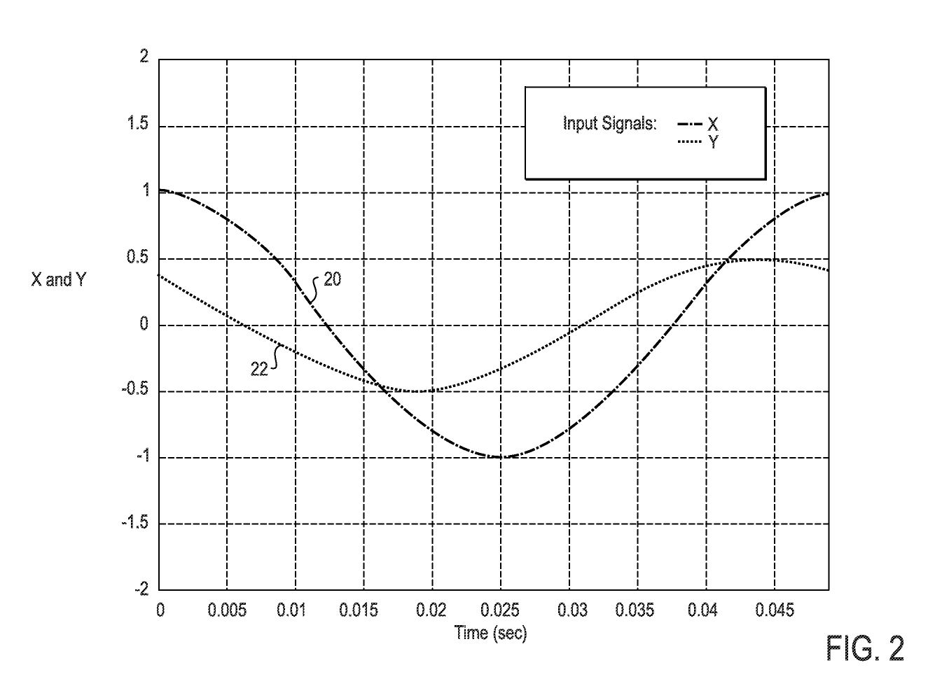

FIG. 2 depicts an example of two signals 20 and 22 isolated or windowed from traces X and Y that are shifted in time relative to each other, according to an embodiment of the present invention. In this example, the selected time window is between approximately 0 second and approximately 0.05 second. In this example, windowed signal 20 and 22 have substantially the same frequency (e.g., 20 Hz). However, the two signals 20 and 22 have different amplitudes and different event times. As shown in FIG. 2, the amplitude of signal 20 is approximately twice the amplitude of signal 22. As also shown in FIG. 2, signal 22 is shifted in time relative to signal 20. The time shift between the signal 20 and the signal 22 is about −0.006 second. If a normalized root mean square (NRMS) is applied to signals 20 and 22, this would result in an anomalous NRMS value.

The method further includes determining a normalized cross-correlation of the two signals 20 and 22 at different time shifts between the two signals, at S14. A normalized cross-correlation Φ_{xy} (r)as a function of time shift τ can be expressed by the following equation (1).

$${φ}_{xy} ( τ ) = \frac{\sum {x}_{i} {y}_{i + τ}}{\sqrt{\sum {x}_{i}^{2}} \sqrt{\sum {y}_{i + τ}^{2}}} \qquad ( 1 )$$

where xᵢ represents the signal 20, and y_{i+τ} represents the signal 22 which is shifted in time by τ samples relative to signal 20.

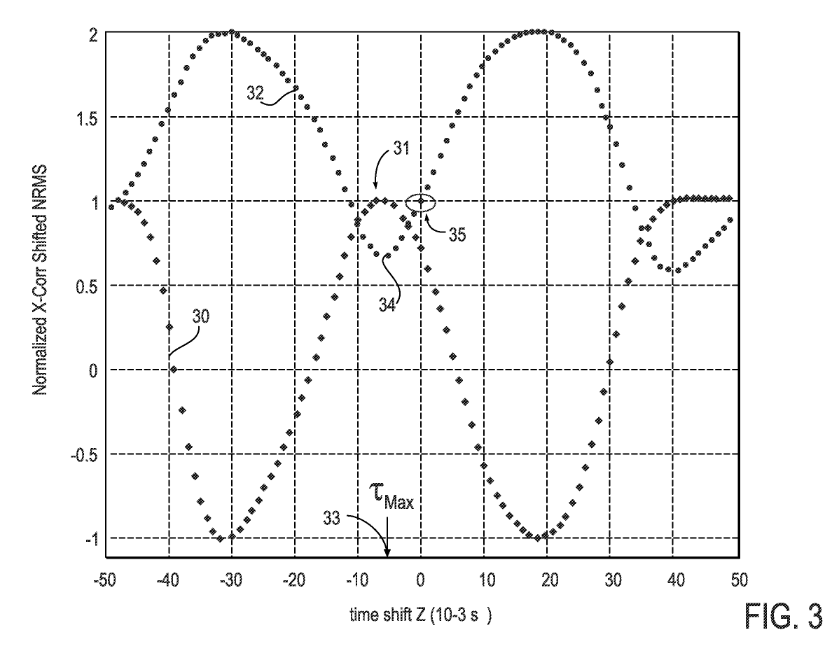

The method further comprises determining an optimum time shift τₘₐₓ closest to zero time shift, τ=0, where the cross-correlation is maximum, at S16. The time shift τₘₐₓ that best aligns signals 20 and 22 results in the largest or maximum cross-correlation. This time shift, noted τₘₐₓ, is close to zero time shift (about −0.006 second in FIG. 3).

FIG. 3 depicts plots of the normalized cross-correlation Φ_{xy} (τ) 30 and the normalized root mean square (NRMS) 32 as a function of the time shift τ, according to an embodiment of the present invention. As shown in FIG. 3, a maximum point 31 of cross-correlation curve 30 occurs at an optimum alignment of the signals 20 and 22 corresponding to optimum time shift τₘₐₓ 33. Optimum time shift τₘₐₓ 33 is close to zero time shift and in this case equal to about −6×10⁻³ second.

The normalized cross-correlation can be performed in either the time-domain or frequency-domain of the signals 20 and 21. In some circumstances, the optimum time shift τₘₐₓ 33 which aligns the two signals 20 and 22 may not fall on a discrete sample of the original data. In this case, the windowed data may be re-sampled to a finer sample interval before applying the cross-correlation or a suitable interpolation method can be used on the cross-correlation to obtain the fractional sample portion of the time shift.

The NRMS 32 is calculated as a function of time shift τ using the following equation (2).

$$NRMS ( τ ) = \frac{2 \times \sqrt{\sum {( {x}_{i} - {y}_{i + τ} )}^{2}}}{\sqrt{\sum {x}_{i}^{2}} + \sqrt{\sum {y}_{i + τ}^{2}}} \qquad ( 2 )$$

The NRMS 32 provides the overall behavior of taking NRMS of signal 22 in trace Y time-shifted relative to signal 20 in trace X. As can be noted in FIG. 3, the NRMS 32 has a better minimum at time shift value equal to 40×10⁻³, which is by happenstance. Because there may be one or more minima in the cross-correlation, the maximum normalized cross-correlation 31 “nearest” time shift equal to zero is utilized to identify the optimum time shift.

The method further comprises computing a shifted normalized root mean square (sNRMS) value at the optimum time shift τₘₐₓ once the optimum time shift τₘₐₓ is determined from the normalized cross-correlation maximum value 31, at S18. The sNRMS value can be calculated using the NRMS as a function of time shift and determining the NRMS value when the time shift is equal to the optimum time shift. The sNRMS can be determined graphically from the above NRMS curve 32 and read when the time shift τ is equal optimum time shift τₘₐₓ 33 to obtain the sNRMS value 34. In this example, the sNRMS value 34 is equal to about 0.7. Alternatively, the sNRMS value can be calculated using the following equation (3).

$$sNRMS ( {τ}_{max} ) = \frac{2 \times \sqrt{\sum {( {x}_{i} - {y}_{i + {τ}_{max}} )}^{2}}}{\sqrt{\sum {x}_{i}^{2}} + \sqrt{\sum {y}_{i + {τ}_{max}}^{2}}} \qquad ( 3 )$$

Furthermore, the “classical” NRMS may also be determined graphically at the time shift τ equal to zero using the NRMS curve 32 by reading the value of the NRMS at τ equal zero. The classical NRMS value is indicated in FIG. 3 at 35. In this example, the classical NRMS value is approximately equal to 1. Alternatively, the classical NRMS can also be calculated using the following equation (4).

$$NRMS ( τ = 0 ) = \frac{2 \times \sqrt{\sum {( {x}_{i} - {y}_{i} )}^{2}}}{\sqrt{\sum {x}_{i}^{2}} + \sqrt{\sum {y}_{i}^{2}}} \qquad ( 4 )$$

The method may further include, optionally, normalizing, at S20, the peak amplitude or energy of the signal 20 and normalizing the peak amplitude or energy of the signal 22, instead of leaving the amplitude of signal 20 twice the amplitude of signal 22, before computing NRMS at τ. In one embodiment, this normalization may be performed on the τₘₐₓ 33 time-shifted signal 22 and the signal 20 just prior to calculating sNRMS(τₘₐₓ), just before S18. However, the normalization may be applied at any stage in the method, for example, just after isolating the two signals from other signals in the two traces, at S12.

The difference in amplitude of the two signals 20 and 22 affect the value of the sNRMS but does not affect the normalized cross-correlation. Hence, if one wishes to determine a sNRMS value for signals with equalized amplitudes, then the shifted signal 22 may be scaled with signal 20, prior to calculating the sNRMS value using the graphical determination method or using equation (3). The signals 20 and 22 can be normalized by either dividing the amplitude of the signals 20 and 22 by their respective peak amplitudes or dividing the amplitude of each signal by the square root of the signal's energy, where the area under each squared-signal corresponds to the “energy” of the signals 20 and 22.

In one embodiment, the method may further include determining a repeatability quality of the signals 20 and 22 based on the sNRMS value, at S22. sNRMS has the same range of values as NRMS. Perfect repeatability has a value of zero. The worst repeatability has a value of 2 corresponding to the same signal but with opposite polarity. Two random Gaussian-noise signals will have a value of 1.414 (i.e., \sqrt{2}). For example, an sNRMS of 0.15 or less may indicate an excellent repeatability. An sNRMS in the range 0.15 to 0.35 may indicate a good repeatability. An sNRMS in the range 0.35 to 0.8 may indicate a fair repeatability. An sNRMS less than 0.8 may indicate a poor repeatability. The quality of repeatability increases with decreasing sNRMS, as will be explained further in detail in the following paragraphs.

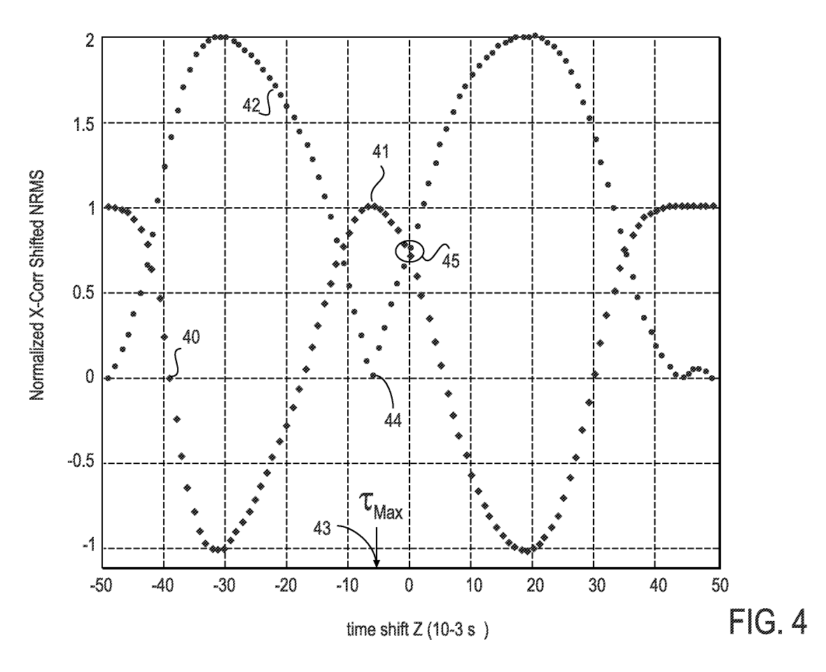

FIG. 4 depicts plots of the normalized cross-correlation Φ_{xy} (τ) 40 and the NRMS 42 as a function or the time shift τ, after normalizing the signals 20 and 22, according to another embodiment of the present invention. FIG. 4 is obtained in the same manner as FIG. 3, except that the signals 20 and 22 are herein further normalized so that the peak amplitude or energy on time-shifted signal 22 matches the peak amplitude or energy on signal 20. As shown in FIG. 4, a maximum point 41 of cross-correlation curve 40 occurs at an optimum alignment of the signals 20 and 22 corresponding to optimum time shift τₘₐₓ 43. The method further comprises computing the sNRMS value 44 once the optimum time shift Tₘₐₓ 43 is determined from the normalized cross-correlation maximum value 41. The sNRMS value 44 can be determined graphically from the NRMS curve 40 and read when the time shift τ is equal optimum time shift Tₘₐₓ 43 to obtain the sNRMS value 44. Alternatively, the sNRMS value 44 can be calculated using equation (3).

FIG. 4 shows that after such a normalization procedure, the sNRMS value 44, determined either graphically or using equation (3), is now near zero indicating that the two signals 20 and 22 are substantially repeatable; i.e., have an excellent repeatability.

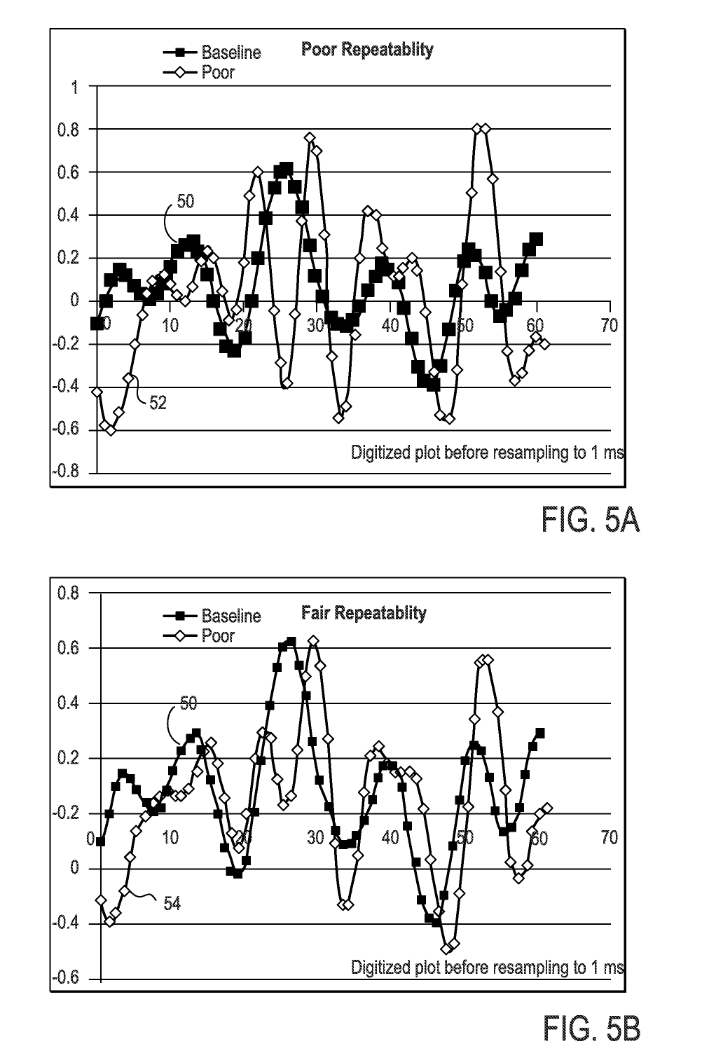

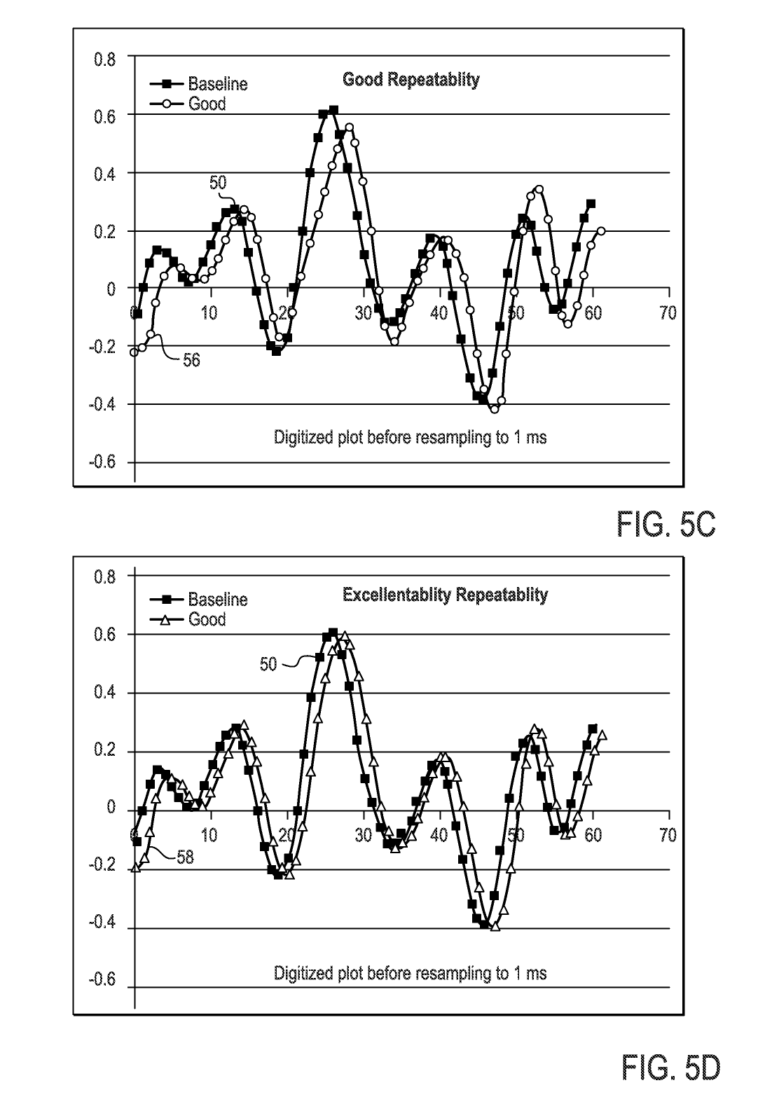

FIGS. 5A-5D are plots of the two time-shifted signals (a baseline signal 50 and repeated signals 52, 54, 56 and 58) in different conditions when a repeatability is poor (FIG. 5A), fair (FIG. 5B), good (FIG. 5C) or excellent (FIG. 5D), according to an embodiment of the present invention. In these plots, the baseline signal 50 corresponds to curve with the square dots. For each of the instances in FIGS. 5A-5D, the sNRMS value can be calculated and presented as percent values (i.e., 100×equation 3). For example, in the case of poor repeatability, as illustrated in FIG. 5A, the calculated sNRMS value is equal to about 117.54. In the case of fair repeatability, as illustrated in FIG. 5B, the sNRMS value is equal to about 80.72. In the case of good repeatability, as illustrated in FIG. 5C, the sNRMS value is equal to about 34.09. In the case of excellent repeatability, as illustrated in FIG. 5D, the sNRMS value is equal to about 14.09.

A relationship between signal-to-distortion ratio (SDR) and NRMS can be found in “Throwing a New Light on Time-Lapse Technology, Metrics and 4D repeatability with SDR,” by Juan Cantillo in The Leading Edge, April 2012, pp. 405-413, (hereinafter referred to as “Cantillo”), the contents of which are incorporated herein by reference. A relationship between NRMS in percent and SDR is given by the following equation (5), extracted from Cantillo.

NRMS=100\sqrt{(2πfτ)²+SDR⁻¹} (5)

where τ corresponds to the time shift and f corresponds to the frequency of the signals.

Using equation (5), an approximate relationship (6) between sNRMS in percent and SDR can be determined by setting τ equal to zero.

sNRMS=100\sqrt{SDR⁻¹} (6)

Hence, for each of the above sNRMS values calculated using the method described herein, for respectively, poor, fair, good and excellent repeatability, a corresponding SDR value can be derived using relationship (6). Table 1 provides a corresponding SDR value derived from the sNRMS value for each of the 4 repeatability scenarios. In addition, as it can be noted in Table 1, the quality of repeatability increases (e.g., from poor to Excellent) with decreasing sNRMS values.

TABLE 1

| REPEATABILITY | sNRMS (in Percent) | Derived SDR |
|---|---|---|
| POOR | 117.54 | 0.7239 |
| FAIR | 80.72 | 1.5349 |
| GOOD | 34.09 | 8.6070 |
| EXCELLENT | 14.72 | 46.1378 |

Similarly, using the SDR values determined in Cantillo, a corresponding sNMRS value can also be derived using equation (6). In this respect, Cantillo provides two different methods for determining the SDR. SDR values (SDR1 and SDR2) for the two Cantillo methods and their corresponding derived sNRMS values (sNRMS1 and sNRMS2) are reported in Table 2.

TABLE 2

| | | Derived | | |
|---|---|---|---|---|
| | | sNRMS1 | | Derived sNRMS2 |
| REPEATABILITY | SDR1 | (in percent) | SDR2 | (in percent) |
| POOR | 0.4453 | 149.85 | 0.1618 | 248.64 |
| FAIR | 1.3693 | 85.46 | 0.8574 | 108.00 |
| GOOD | 8.9936 | 33.34 | 8.009 | 35.34 |
| EXCELLENT | 46.5148 | 14.66 | 45.5304 | 14.82 |

As it can be seen in TABLE 2, the two equations in Cantillo used to compute SDR produce diverging SDR values SDR1 and SDR2, as the repeatability between the two signals worsens (from Excellent to Poor). In addition, the SDR values increase with increasing quality of repeatability (from poor to excellent repeatability). Furthermore, as it can be seen in Table 1 and Table 2, the equation linking SDR to sNRMS is a good approximation for the Excellent and Good scenarios as the value of sNMRS (14.72 for excellent repeatability and 34.09 for good repeatability) obtained using the method described herein and the sNRMS value (14.82 for excellent repeatability and 35.34 for good repeatability) derived from SDR2 (45.5304 for excellent repeatability and 8.009 for good repeatability) are approximately equal. However, as it can be noted from Table 1 and Table 2, the sNRMS obtained using the method described herein and the sNRMS derived from the SDR diverge at poor repeatability where the sNRMS derived from SDR becomes unphysical (derived sNRMS greater than 200).

Thus, the sNRMS obtained using the method described herein is robust for any level of repeatability while sNRMS derived from SDR is not robust and can lose its physical significance for data with poor repeatability. The SDR metric can be approximately tied to the sNRMS metric described herein only for good-to-excellent quality data at small time shifts.

The sNRMS method described herein provides valid estimates of NRMS. The sNRMS method described herein robustly works with time shifts between seismic data sets and can be used both as a valid repeatability metric and in further analysis of the 4D data.

As a metric, the sNRMS method described herein can be used as a quality control (QC) metric in the co-processing of 4D seismic data. However, in addition to being used as a QC metric, the sNRMS method described herein can further be used in analysis of baseline seismic data for use in time-lapse seismic planning

In one embodiment, the method or methods described above can be implemented as a series of instructions which can be executed by a computer. As it can be appreciated, the term “computer” is used herein to encompass any type of computing system or device including a personal computer (e.g., a desktop computer, a laptop computer, or any other handheld computing device), or a mainframe computer (e.g., an IBM mainframe), or a supercomputer (e.g., a CRAY computer), or a plurality of networked computers in a distributed computing environment.

For example, the method(s) may be implemented as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media.

Alternatively, a portion or the whole software program product can be downloaded from a remote computer or server via a network such as the internet, an ATM network, a wide area network (WAN) or a local area network.

Alternatively, instead or in addition to implementing the method as computer program product(s) (e.g., as software products) embodied in a computer, the method can be implemented as hardware in which for example an application specific integrated circuit (ASIC) can be designed to implement the method.

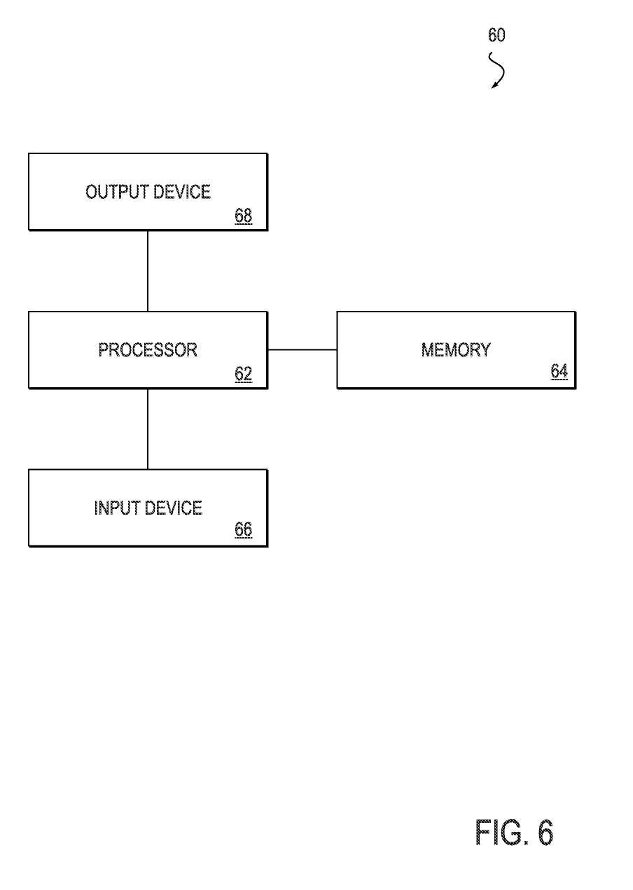

FIG. 6 is a schematic diagram representing a computer system 100 for implementing the method, according to an embodiment of the present invention. As shown in FIG. 6, computer system 60 comprises a processor (e.g., one or more processors) 62 and a memory 64 in communication with the processor 62. The computer system 60 may further include an input device 66 for inputting data (such as a keyboard, a mouse or the like) and an output device 68 such as a display device for displaying results of the computation.

As can be appreciated from the above description, the computer readable memory 64 can be configured to store input data comprising two seismic traces that include similar or repeatable signals. The computer processor 62, in communication with the computer readable memory 64, is configured to: read the input data; isolate two signals for analysis from other signals in the two seismic traces, the two signals being time shifted relative to each other; determine a normalized cross-correlation of the two signals at different time shifts between the two signals; determine an optimum time shift closest to zero time shift where the normalized cross-correlation is maximum; compute a shifted normalized root mean square value at the optimum time shift; and determine a repeatability quality of the two signals based on the shifted normalized root mean square value.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A computer implemented method for evaluating a time-lapse seismic signal recording using shifted normalized root mean square (sNRMS) metric, the method comprising:
inputting, into a computer, two seismic traces that include similar or repeatable signals;
isolating, by the computer, two signals for analysis from other signals in the two seismic traces, the two signals being time shifted relative to each other;
determining, by the computer, a normalized cross-correlation of the two signals at different time shifts between the two signals;
determining, by the computer, an optimum time shift closest to zero time shift where the normalized cross-correlation is maximum;
computing, by the computer, a shifted normalized root mean square value at the optimum time shift; and
determining, by the computer, a repeatability quality of the two signals based on the shifted normalized root mean square value.

2. The method according to claim 1, wherein the repeatability quality increases with decreasing shifted normalized root mean square value.

3. The method according to claim 1, wherein isolating the two signals comprises selecting a time window in the two seismic traces.

4. The method according to claim 1, wherein determining the normalized cross-correlation comprises calculating a product of the two signals.

5. The method according to claim 1, wherein determining the normalized cross-correlation comprises determining the cross-correlation in a time domain or a frequency domain of the two signals.

6. The method according to claim 1, wherein computing the shifted normalized root mean square value at the optimum time shift comprises using a normalized root mean square as a function of time shift and determining the normalized root mean square value when the time shift is equal to the optimum time shift.

7. The method according to claim 1, further comprising normalizing the two signals so as to equalize peak amplitudes or energies of the two signals.

8. The method according to claim 7, wherein normalizing the two signals comprising dividing an amplitude of each signal by a peak amplitude of each respective signal or dividing the amplitude of each signal by the square root of the energy of each respective signal.

9. A system for evaluating a time-lapse seismic signal recording using shifted normalized root mean square (sNRMS) metric, the system comprising:
a computer readable memory configured to store input data comprising two seismic traces that include similar or repeatable signals; and
a computer processor in communication with the computer readable memory, the computer processor being configured to:
read the input data;
isolate two signals for analysis from other signals in the two seismic traces, the two signals being time shifted relative to each other;
determine a normalized cross-correlation of the two signals at different time shifts between the two signals;
determine an optimum time shift closest to zero time shift where the normalized cross-correlation is maximum;
compute a shifted normalized root mean square value at the optimum time shift; and
determine a repeatability quality of the two signals based on the shifted normalized root mean square value.

10. The system according to claim 9, wherein the repeatability quality increases with decreasing shifted normalized root mean square value.

11. The method according to claim 9, wherein the processor is configured to isolate the two signals by selecting a time window in the two seismic traces.

12. The method according to claim 9, wherein the processor is configured to compute the shifted normalized root mean square value at the optimum time shift by using a normalized root mean square as a function of time shift and determining the normalized root mean square value when the time shift is equal to the optimum time shift.

13. The method according to claim 9, wherein the processor is configured to further normalize the two signals so as to equalize amplitudes of the two signals.

14. The method according to claim 13, wherein the processor is configured to normalize the two signals by dividing an amplitude of each signal by a peak amplitude of each respective signal or dividing the amplitude of each signal by the square root of an energy of each respective signal.
